(19) United States
(12) Patent Application Publication
(10) Pub. No.: US 2012/0212404 A1
(43) Pub. Date: Aug. 23, 2012

(54) INFORMATION PROCESSING DEVICE, INFORMATION PROCESSING TERMINAL DEVICE, INFORMATION PROCESSING SYSTEM, INFORMATION PROCESSING METHOD, AND COMPUTER READABLE STORAGE MEDIUM

(75) Inventor: Kazushi YOSHIDA, Kawasaki-shi (JP)

(73) Assignee: Sony Computer Entertainment Inc., Tokyo (JP)

(21) Appl. No.: 13/209,897

(22) Filed: Aug. 15, 2011

(30) Foreign Application Priority Data
Aug. 18, 2010 (JP) 2010183403

(51) Int. Cl. G06F 3/01

(52) U.S. Cl. 345/156

(57) ABSTRACT

An information processing device includes an input information obtaining unit configured to obtain first input information and second input information among input information items, an input candidate information obtaining unit configured to obtain one or more input candidate information items as a candidate for the second input information, based on the first input information, an executing unit configured to carrying out an application, based on the one or more input candidate information items, to produce one or more image candidate information items, an image candidate information storage unit configured to store the one or more image candidate information items so as to be correlated to the one or more input candidate information items respectively, and a transmitting unit configured to send information relating to one or all of the one or more image candidate information items stored in the image candidate information storage unit to a terminal device.

### CROSS-REFERENCE TO RELATED APPLICATION

The present application claims priority from Japanese application JP2010-183403 filed on Aug. 18, 2010, and the Japanese application is hereby incorporated by reference into this application.

### BACKGROUND OF THE INVENTION

1. Field of the Invention

One or more embodiments of the present invention relate to an information processing device, an information processing terminal device, an information processing system, an information processing method, and a computer readable storage medium storing an information process program.

2. Description of the Related Art

There have been known so-called on-line games in which a server receives input information to a user terminal and then sends a result of processing carried out based on the input information to the terminal, and an image is shown on a screen in the terminal, based on the received processing result.

### SUMMARY OF THE INVENTION

According to the above described conventional technique, every time when receiving input information from a client, the server produces an image based on the input information. Because it takes a time to execute the image producing process, it takes a certain amount of time to display an image based on the input information on the display unit of the client after inputting the input information to the client's operating unit. As a result, there may be a problem that displaying the image may be delayed.

One or more embodiments of the present invention have been conceived in view of the above, and aims to provide an information processing device, an information processing terminal device, an information processing system, an information processing method, or a computer readable storage medium storing an information process program capable of reducing a time period from receiving input information in an information processing device to sending a result of processing and displaying an image or the like in an information processing terminal.

In view of the above, according to one aspect of the present invention, there is provided an information processing device including an input information obtaining unit configured to obtain, via a network, at least first input information and second input information among input information items that are inputted to a terminal device. The second input information is input information subsequent to the first input information. The information processing device also includes an input candidate information obtaining unit configured to obtain one or more input candidate information items as a candidate for the second input information, based on the first input information, and an executing unit configured to carrying out an application, based on the one or more input candidate information items, to produce one or more image candidate information items. The one or more image candidate information items are one or more image information items that correspond to the one or more respective input candidate information items. The information processing device further includes an image candidate information storage unit configured to store the one or more image candidate information items so as to be correlated to the one or more input candidate information items respectively, and a transmitting unit configured to send information relating to one or all of the one or more image candidate information items stored in the image candidate information storage unit to the terminal device via a network.

According to another aspect of the present invention, there is provided an information processing terminal device including an input information transmitting unit configured to send, via a network, at least first input information and second input information among input information items that are inputted to the information processing terminal device. The second input information is input information subsequent to the first input information. The information processing terminal device also includes an image candidate information storage unit configured to obtain and store one or more image candidate information items correlated to one or more respective input candidate information items as a candidate for the second input information, a search unit configured to search input candidate information corresponding to the second input information among the one or more image candidate information items that are stored in the image candidate information storage unit, and an image reproduction unit configured to reproduce an image based on image candidate information that is correlated to the input candidate information corresponding to the second input information, when the search unit determines that the input candidate information corresponding to the second input information is stored in the image candidate information storage unit.

According to still another aspect of the present invention, there is provided an information processing system including an input information obtaining unit configured to obtain, via a network, at least first input information and second input information among input information items that are inputted to a terminal device. The second input information is input information subsequent to the first input information. The information processing unit also includes an input candidate information obtaining unit configured to obtain one or more input candidate information items as a candidate for the second input information, and an executing unit configured to carry out an application, based on the one or more input candidate information items, to produce one or more image candidate information items. The one or more image candidate information items are one or more image information items that correspond to the one or more input candidate information items respectively. The information processing system further includes an image candidate information storage unit configured to store the one or more image candidate information items so as to be correlated to the one or more corresponding input candidate information items respectively, a search unit configured to searching input candidate information corresponding to the second input information among the one or more image candidate information items stored in the image candidate information storage unit, and an image production unit configured to reproduce image candidate information that is stored so as to be correlated to the corresponding input candidate information when the search unit determines that the input candidate information corresponding to the second input information is stored.

According to still another aspect of the present invention, there is provided an information processing method including obtaining, via a network, at least first input information and second input information among input information items that are input to a terminal device. The second input information is input information subsequent to the first input information. The information processing method includes obtaining one or more input candidate information items as a candidate for the second input information, based on the first input information and carrying out an application, based on the one or more input candidate information items, to produce one or more image candidate information items. The one or more image candidate information items are one or more image information items that correspond to the one or more input candidate information items respectively. The information processing method includes storing the one or more image candidate information items so as to be correlated to the one or more input candidate information items respectively and sending information relating to one or all of the one or more image candidate information items stored in an image candidate information storage unit to the terminal device via a network.

According to still another aspect of the present invention, there is provided an information processing method including obtaining, via a network, at least first input information and second input information among input information items that are inputted to a terminal device. The second input information is input information subsequent to the first input information. The information processing method includes obtaining one or more input candidate information items as a candidate for the second input information and carrying out an application, based on the one or more input candidate information items, to produce one or more image candidate information items. The one or more image candidate information items are one or more image information items that correspond to the one or more input candidate information items respectively. The information processing method further includes storing the one or more image candidate information items so as to be correlated to the one or more corresponding input candidate information items respectively, searching input candidate information corresponding to the second input information among the one or more image candidate information items stored in an image candidate information storage unit, and when no input candidate information corresponding to the second input information is stored, reproducing image candidate information stored so as to be correlated to the corresponding input candidate information.

According to still another aspect of the present invention, there is provided a computer readable storage medium storing the information processing program for causing a computer to function as an input information obtaining unit configured to obtain, via a network, at least first input information and second input information among input information items that are inputted to a terminal device. The second input information is input information subsequent to the first input information. The program causes a computer to function also as an input candidate information obtaining unit configured to obtain in one or more input candidate information items as a candidate for the second input information, based on the first input information, and an executing unit configured to carry out an application, based on the one or more input candidate information items, to produce one or more image candidate information items. The one or more image candidate information items are one or more image information items that correspond to the one or more input candidate information items respectively. The program causes a computer to function also as an image candidate information storage unit configured to store the one or more image candidate information items so as to be correlated to the one or more input candidate information items respectively and a transmitting unit configured to send information relating to one or all of the one or more image candidate information items stored in the image candidate information storage unit to the terminal device via a network.

According to still another aspect of the present invention, there is provided a computer readable storage medium storing an information processing program for causing a computer to function as an input information transmitting unit configured to send, via a network, at least first input information and second input information among input information items that are input into a terminal device. The second input information is input information subsequent to the first input information. The program causes a computer to function also as an image candidate information storage unit configured to obtain and store one or more image candidate information items correlated to one or more respective input candidate information items as a candidate for the second input information, a search unit configured to search input candidate information corresponding to the second input information among the one or more image candidate information items that are stored in the image candidate information storage unit, and an image reproduction unit configured to reproduce an image based on image candidate information correlated to the input candidate information corresponding to the second input information when the search unit determines that the input candidate information corresponding to the second input information is stored in the image candidate information storage unit.

According to one or more embodiments of the present invention, it is possible to reduce a time period from inputting input information to a terminal device to reproducing an image for the input information, compared to a case without employing the present invention.

### BRIEF DESCRIPTION OF THE DRAWINGS

FIG. 1 is a diagram explaining a schematic hardware structure of an information processing system in a first embodiment;

FIG. 2 is a diagram showing an example of external appearance of a terminal in the first embodiment;

FIG. 3 is a diagram functionally explaining a structure of a server in the first embodiment;

FIG. 4 is a diagram showing one example of a format for storage in an image candidate information storage unit in the first embodiment;

FIG. 5 is a diagram functionally explaining a structure of a terminal in the first embodiment;

FIG. 6 is a diagram explaining a schematic operation of an information processing system in the first embodiment;

FIG. 7 is a diagram explaining a flow of an image candidate information producing process carried out in a server in the first embodiment;

FIG. 8 is a diagram explaining a process from obtaining input information by a server from a terminal to transmission of image information or image candidate information to the terminal in the first embodiment;

FIG. 9 is a diagram explaining an effect of the first embodiment;

FIG. 10 is a diagram functionally explaining a structure of a server in a second embodiment;

FIG. 11 is a diagram functionally explaining a structure of a terminal in the second embodiment;

FIG. 12 is a diagram explaining a schematic operation of an information processing system in the second embodiment;

FIG. 13 is a diagram explaining a flow of a process carried out in a terminal in the second embodiment;

FIG. 14 is a diagram explaining a flow of production of image candidate information by a server in the second embodiment; and

FIG. 15 is a diagram explaining an effect of the second embodiment.

### DETAILED DESCRIPTION OF THE INVENTION

In the following, first and second embodiments of the present invention will be described referring to the accompanying drawings. In the drawings, identical or equivalent elements are given an identical reference numeral and description thereof will not be repeated.

### First Embodiment

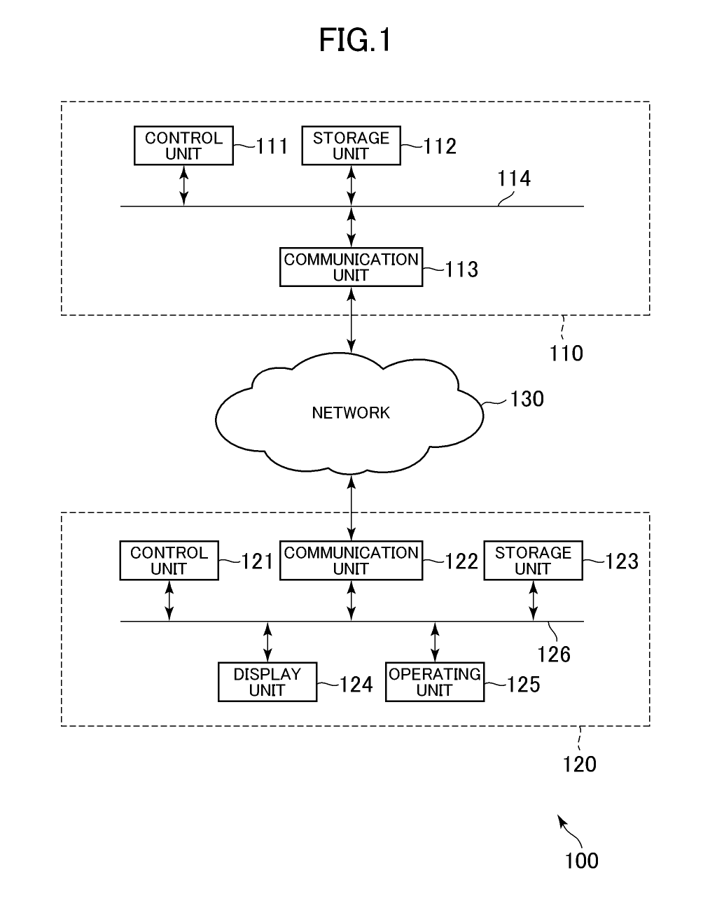

FIG. 1 is a diagram explaining a schematic hardware structure of an information processing system according to a first embodiment of the present invention. As shown in FIG. 1, the information processing system 100 includes a server 110 and a terminal 120 connected to each other via a network 130 (e.g., the Internet). Although the information processing system 100 has only one terminal 120 in FIG. 1, the information processing system 100 may have two or more terminals 120.

The server 110 includes a control unit 111, a storage unit 112, and a communication unit 113. The control unit 111 is a CPU or the like, and operates according to a program stored in the storage unit 112. The storage unit 112 is formed using an information recording medium, such as, a hard disk, a ROM, a RAM, and stores a program to be carried out by the control unit 111.

The storage unit 112 operates also as a working memory of the control unit 111.

The communication unit 113 is a network interface for receiving and sending information via the network 130 according to an instruction from the control unit 111. The control unit 111, storage unit 112, and communication unit 113 are connected to one another via a bus 114.

The terminal 120 includes a control unit 121, a communication unit 122, a storage unit 123, a display unit 124, and an operating unit 125, which, similarly, are connected to one another via a bus 126. Similar to the server 110, the control unit 121 is a CPU or the like, and operates according to a program stored in the storage unit 112. The storage unit 123 is formed using an information recording medium, such as a hard disk, a ROM, a RAM, and stores a program to be carried out by the control unit 121. The storage unit 123 operates also as a working memory of the control unit 121.

The operating unit 125 is formed using an interface, such as, a keyboard, a mouse, a controller, a button, and, in response to a user designation operation, outputs content of the designation operation to the control unit 121. The display unit 124 is, e.g., a liquid crystal display, a CRT display, an organic EL display, and shows information according to an instruction from the control unit 121.

A program carried out by the control units 111 and 121 may be provided through downloading via, e.g., a network or by means of various computer readable information recording media, such as a CD-ROM, a DVD-ROM, or the like. The above described structures of the server 110 and the terminal 120 are mere examples and do not limit the present invention. Functional structures of the server 110 and terminal 120 will be described later in detail.

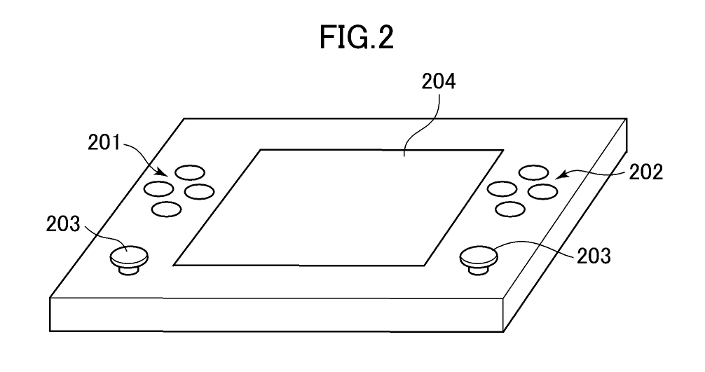

FIG. 2 is a diagram showing one example of an external appearance of a terminal device (terminal). As shown in FIG. 2, the terminal 120 includes, e.g., a direction key 201, a plurality of buttons 202, and an analog operating unit 203 as the operating unit 125, and a display screen 204 as the display unit 124.

The direction key 201 includes, e.g., an upper direction designation key, a lower direction designation key, a right direction designation key, and a left direction designation key. Using the direction key 201, for example, a user moves an object shown on the screen in the up, down, left, and right directions.

The plurality of buttons 202 are marked as, e.g., a, b, c, d, and so forth, respectively. A user can carry out a process assigned to each button 202 according to an ongoing application by pressing the button 202. Note that the respective buttons marked as a, b, c, d, and so forth will be hereinafter referred to as the button a, button b, button c, and button d, and information that is input by pressing the respective buttons a, b, c, and d will be hereinafter referred to as input information a, b, c, and d.

The analog operating unit 203 is adapted to inclination operation relative to, e.g., a predetermined reference position. That is, a user inputs input information in accordance with the amount and direction of inclination of the analog operating unit 203 relative to the reference position. For example, using the analog operating unit 203, a user can have an object shown on the screen inclined by a desired amount in a desired direction according to an inclination amount and direction of the operating unit 203.

The display screen 204 corresponds to the display screen of the display unit 124, and shows, e.g., an image or the like according to an application (application program).

Note that the external appearances of the terminal 120, operating unit 125, and display unit 124 shown in FIG. 2 are mere examples, and do not limit the present invention. Specifically, the operating unit 125 may be formed using a touch panel, and the display unit 124 may be a display screen of a monitor or the like formed using a CRT or a liquid crystal display device. Further, the number of direction key 201, button 202, and analog operating unit 203 may be any number other than those mentioned above, and the terminal 120 may have any buttons, such as a start button or a select button (not shown), other than those mentioned above, and may also have an accelerator sensor or the like.

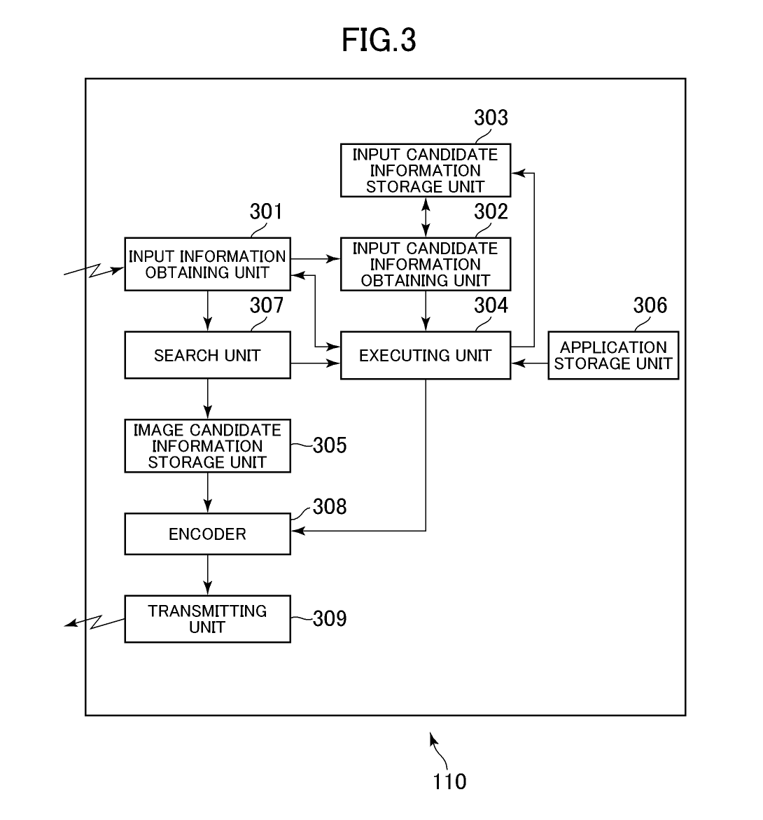

FIG. 3 is a diagram functionally explaining a structure of a server. As shown in FIG. 3, the server 110 includes an input information obtaining unit 301, an input candidate information obtaining unit 302, an input candidate information storage unit 303, an executing unit 304, an image candidate information storage unit 305, an application storage unit 306, a search unit 307, an encoder 308, and a transmitting unit 309. For example, mainly the executing unit 304, input candidate information obtaining unit 302, search unit 307, and encoder 308 correspond to the function of the control unit 111; mainly the input information obtaining unit 301 and transmitting unit 309 correspond to the function of the communication unit 113; and mainly the input candidate information storage unit 303, image candidate information storage unit 305, and application storage unit 306 correspond to the function of the storage unit 112.

The input information obtaining unit 301 obtains input information from the terminal 120 via the network 130. Specifically, for example, one or more input information items are successively obtained from a terminal for every frame period. In this specification, for brevity of description, input information obtained at a certain time point is referred to as “current input information”; input information obtained at the next time point is referred to as “next input information”; and input information obtained before the time point is referred to as “previous input information”. Note that although it is described above that input information is obtained for every frame period, input information may be obtained at any other frame period, such as for every second frame period.

The input candidate information obtaining unit 302 searches the input candidate information storage unit 303 to be described later, based on the input information (e.g., the current input information) received from the input information obtaining unit 301, and obtains one or more candidates for input information, or input candidate information (input candidate information for the next input information).

“Input candidate information” here refers to information relating to either all of the candidates for input information to be input immediately after the input information input at a certain time point or candidates for input information to be highly likely input immediately after the input information input at a certain time point. Specifically, for example, for an application involving only a smaller number of input information items, such as an application using only the button a or c, all of the candidates may be determined as input candidate information. Meanwhile, when an application involves a larger number of buttons, a candidate for input information to be highly likely input next, in other words, only a predetermined number of candidates, may be determined as input candidate information. In the above, which of all candidates for input information to be input immediately after the input information input at a certain time point and candidates for input information to be highly likely input immediately after the input information input at a certain time point are determined as input candidate information may be determined based on, e.g., a capacity of and/or a load on the server 110 side or an application to be carried out.

Note that the input candidate information obtaining unit 302 may obtain input candidate information from the image candidate information storage unit 305, based not only on the current input information but also on one or more input information items having been obtained before the current input information, a game title, game progress, and so forth.

The input candidate information storage unit 303 stores input information at least at a certain time point and one or more input candidate information items as a candidate/candidates for the next input information so as to be correlated to each other. For example, with respect to the input information “a”, input information “b”, “c”, “d”, and so forth may be stored as candidates for the next input information. Further, in addition to the input information at a certain time point and one or more input candidate information items as a candidate/candidates for the next input information, one or more input candidate information items as a candidate/candidates for further subsequent input information may be stored. In this case, input candidate information or the like in how further in future is stored may be determined based on the amount of delay or the like in communication between the server 110 and the terminal 120.

Information stored in the input candidate information storage unit 303 may be stored, e.g., for every application, for every progress of an application, or for every scene. Specifically, for an application of a game that is carried out using only the left and right direction keys 201, with respect to the current input information “right direction key”, either “left direction key” or “right direction key” may be stored as input candidate information as a candidate for the next input information.

Further, information stored in the input candidate information storage unit 303 may be set, e.g., for every application carried out by the executing unit 304, based on rule information applicable to applications in general, information statically determined for each application, statistical information about input information for each game, and so forth.

“Rule information applicable to applications in general” here includes, e.g., “when the button a is kept pressed at a certain time point, the button a is highly likely kept pressed/released at the next time point”, “a start button or a select button is very unlikely used”, “a direction key is often used”, “an analog key will not be changed abruptly from a previous state thereof”, and so forth.

Specifically, when the rule “when the button a is kept pressed at a certain time point, the button a is highly likely kept pressed/released at the next time point” is applied, with respect to the current input information “a”, for example, input information “a” may be stored as input candidate information as a candidate for the next input information when the rule “the button a is highly likely kept pressed” is applied, and input information other than “a”, (e.g., “b”, “c”, “d”) may be stored as input candidate information as a candidate for the next input information when the rule “the button a is highly likely released” is applied.

When the rule “a start button or a select button is very unlikely used” is applied, input candidate information corresponding to “start button” and “select button” may be excluded from input candidate information as a candidate for the next input information.

When the rule “a direction key is often used” is applied and the number of input candidate information is limited to so as to be highly likely input, e.g., input candidate information corresponding to “direction key” may be included with priority over others information as a candidate for the next input information.

When the rule “the analog operating unit 203 will not be changed abruptly from a previous state thereof” is applied and the number of input candidate information is limited to a predetermined number, e.g., a candidate corresponding to a result of abrupt change from the current input information may be excluded from the input candidate information as a candidate for the next input information.

“Information statically determined for each application” refers to information such as, e.g., “the buttons c and d are not used in some game”. In this case, e.g., input information items “c” and “d” are excluded from the input candidate information.

“Statistical information about input information for each game” refers to information such as “most users use only the direction key 201 in some scene in some game”. In this case, e.g., information (i.e., “a”, “c”, and so forth) other than “direction key” may be excluded from the input candidate information. Note that the statistical information may be obtained by the server 110 from, e.g., program counters or the like of a plurality of terminals 120.

The executing unit 304 carries out an application stored in the application storage unit 306 to produce image information or image candidate information, based on the current input information or input candidate information. The executing unit 304 carries out an application on, e.g., an emulator to produce image information or image candidate information. A specific process carried out by the executing unit 304 will be described later.

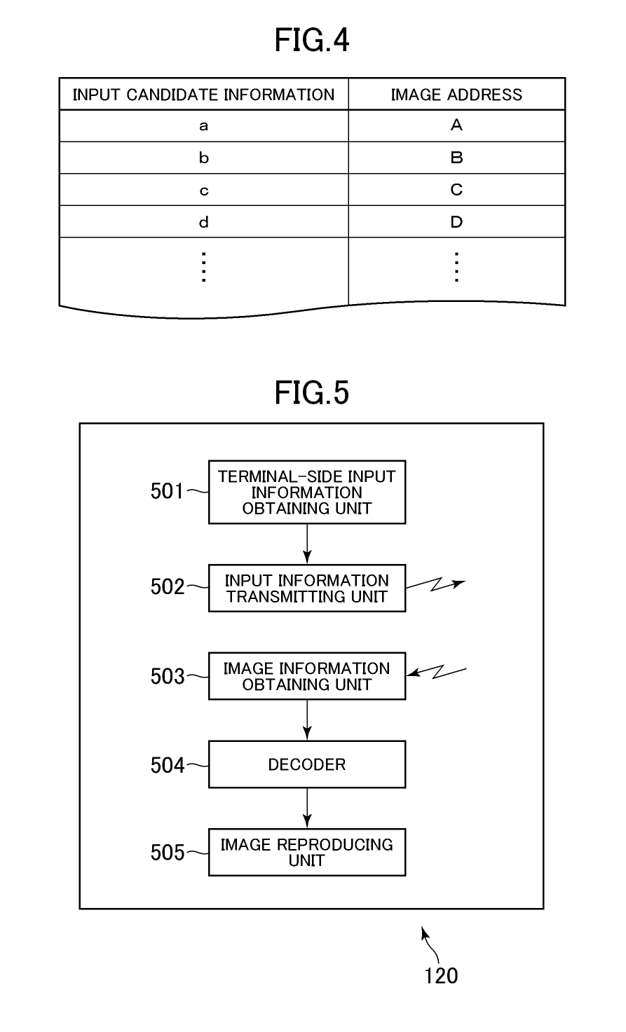

The image candidate information storage unit 305 stores image candidate information so as to be correlated to the input candidate information. Specifically, an address of image candidate information is stored so as to be correlated to the input candidate information in the table shown in FIG. 4. The table in FIG. 4 shows that the image candidate information storage unit 305 stores image addresses A, B, C, and D of the respective image candidate information items so as to be correlated to the input candidate information items a, b, c, and d, respectively.

The search unit 307 searches the image candidate information storage unit 305 for image candidate information corresponding to the current input information. Then, when it is determined that image candidate information corresponding to the current input information is stored in the image candidate information storage unit 305, that image candidate information is sent to the encoder 308.

Specifically, in FIG. 4, assume that the current input information is input information “a”. In this case, because input candidate information “a” is stored, image candidate information having image address “A” is sent to the encoder 308.

Note that the search unit 307 may regard stored image candidate information corresponding to input candidate information, which may vary within a predetermined range from the input candidate information corresponding to the current input information, as image candidate information corresponding to the current input candidate information. For example, assume that the current input information is read as “the analog operating unit 203 is inclined halfway to the left”. In this case, if image candidate information according to “the analog operating unit 203 is fully inclined to the left (corresponding to input candidate information that may vary within a predetermined range)” is stored in the image candidate information storage unit 305, the search unit 307 may determine that image candidate information corresponding to the current input information, namely, “the analog operating unit 203 is inclined halfway to the left”, is stored. In the above, the predetermined range may be determined for each application. The above described manner of determination using the analog operating unit 203 may be similarly applied to a case in which the terminal 120 has an accelerator sensor.

Meanwhile, when the search unit 307 determines that no image candidate information corresponding to the current input information is stored in the image candidate information storage unit 305, the search unit 307 instructs the executing unit 304 to produce image information, based on the current input information. Accordingly, the executing unit 304 obtains the current input information from the input information obtaining unit 301, then produces image information based on the current input information, and sends the produced image information to the encoder 308. Specifically, for example, a running state (a value of a memory or a register) of the executing unit 304 (e.g., an emulator) is stored as a snap shot in, e.g., the executing unit 304, and image information is produced using a snap shot at an appropriate time point, based on the current input information. Note that the above described snap shot corresponds to a previous snap shot (a snap shot corresponding to the previous input information). However, obviously, a further previous snap shop may be held, depending on a delay in communication between the server 110 and the terminal 120.

The encoder 308 compresses (encode) the image information or image candidate information. The transmitting unit 309 sends the compressed image information or image candidate information to the terminal 120.

Note that the structure of the server 110 shown in FIG. 3 is a mere example, and can be modified in various manners. For example, a structure substantially identical to that shown in FIG. 3, a structure producing identical operational effect, or a structure achieving an identical object can substitute the structure.

Specifically, for example, although the server 110 has the input candidate information storage unit 303 in FIG. 3, a database (not shown) may be provided outside the server 110 so that the input candidate information obtaining unit 302 obtains input candidate information from the database via the network 130. Further, image information or image candidate information may be compressed by the encoder 308 before being stored in the image candidate information storage unit 305 and sent by the transmitting unit 309.

FIG. 5 is a diagram functionally explaining a structure of a terminal. As shown in FIG. 5, the terminal 120 includes a terminal-side input information obtaining unit 501, an input information transmitting unit 502, an image information obtaining unit 503, a decoder 504, and an image reproducing unit 505. For example, mainly the terminal-side input information obtaining unit 501, input information transmitting unit 502, and image information obtaining unit 503 correspond to the communication unit 122, and mainly the decoder 504 and image reproducing unit 505 correspond to the control unit 121.

The terminal-side input information obtaining unit 501 obtains input information (e.g., information such as “the button d is pressed”) input on the operating unit 125. The input information transmitting unit 502 sends the input information to the server 110.

The image information obtaining unit 503 obtains the compressed image candidate information or image information from the server 110. The decoder 504 decodes the compressed image candidate information or image information.

The image reproducing unit 505 produces a display image, using the decoded image candidate information or image information, and shows on the display unit 124.

Note that the structure of the terminal 120 shown in FIG. 5 is one example, and can be modified in various manners. For example, a structure substantially identical to the structure shown in FIG. 5, a structure producing an identical operational effect, or a structure achieving an identical object can substitute the structure. A specific process carried out by the server 110 and the terminal 120 will be described later.

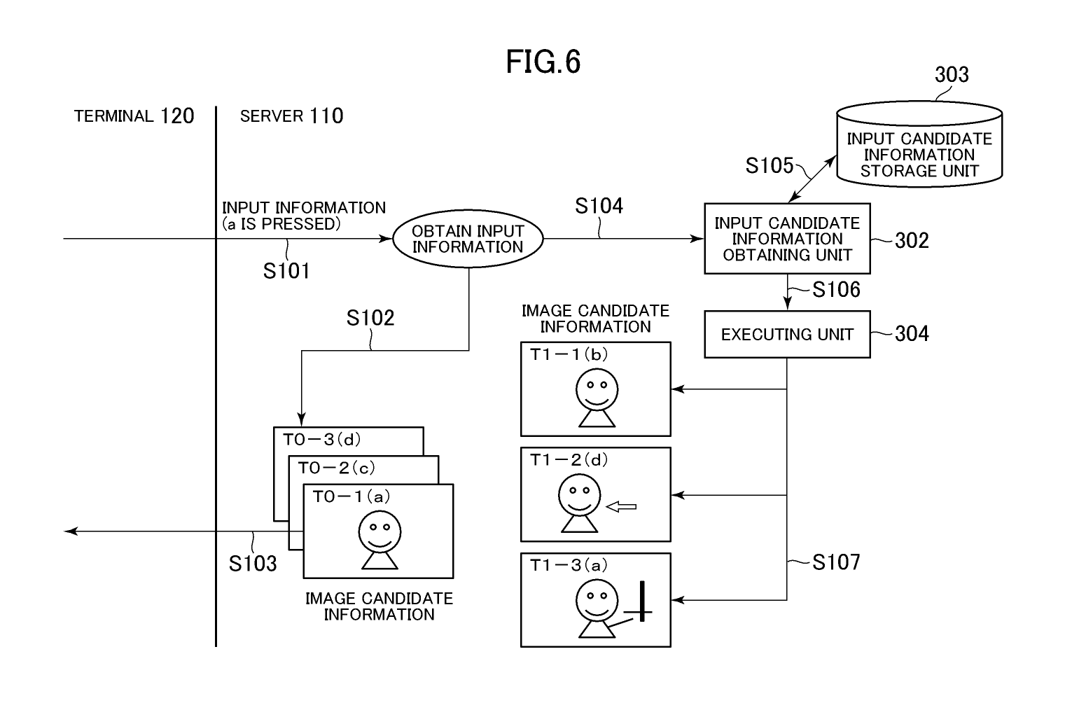

In the following, an operation of the information processing system 100 in this embodiment will be described, referring to FIG. 6.

As shown in FIG. 6, the terminal 12 sends input information (current input information) to the input information obtaining unit 301, which thereby obtains the current input information (S101). In FIG. 6, the current input information is read as “the button a is pressed”. The input information is sent for every frame of an image shown on the display unit 124, and obtained. However, the input information is not necessarily sent for every frame of an image but may be sent to the server 110 when any change is made to the input information.

Thereafter, the search unit 307 searches the image candidate information storage unit 305 for image candidate information corresponding to the current input information (S102). In this example, as shown in FIG. 6, image candidate information items T0-1 to T0-3 corresponding to the respective input information items related to the respective buttons a, c, and d are stored so as to be correlated to the respective input candidate information items in the image candidate information storage unit 305. Note that in the above the image candidate information items T0-1 to T0-3 are three image candidate information items that are produced based on the previous input information. That is, three input candidate information items are produced as candidates for the current input information, based on the previous input information, and three image candidate information items are produced, and stored so as to be correlated to, these three image candidate information items. The above described image candidate information items T0-1 to T0-3 correspond to these three image candidates information items stored so as to be correlated to these input candidate information items.

Specifically, in FIG. 6, since the current input information is input information “a”, the search unit 307 determines if there is any image candidate information stored so as to be correlated to input candidate information “a”. In this case, as image candidate information T0-1 is stored so as to be correlated to the input candidate information “a”, it is determined that there is image candidate information “T0-1” stored corresponding to the current input information. Therefore, the image candidate information T0-1 is compressed by the encoder 308, and sent to the terminal 120 (S103).

Meanwhile, the input candidate information obtaining unit 302 obtains current input candidate information (S104). Specifically, the input candidate information obtaining unit 302 searches the input candidate information storage unit 303, based on the current input information received from the input information obtaining unit 301, and obtains input candidate information as a candidate for the next input information (S105). Thereafter, the input candidate information obtaining unit 302 sends the obtained input candidate information to the executing unit 304 (S106).

Based on the input candidate information received, the executing unit 304 carries out an application to produce image candidate information items T1-1 to T1-3 for the respective input candidate information items (S107). In the above, note that, as shown in FIG. 6, the image candidate information items T1-1, T1-2, and T1-3 correspond to the input information items related to the buttons b, d, and a, respectively. The image candidate information items T1-1 to T1-3 are stored in the image candidate information storage unit 305, and subjected to be searched for by the search unit 307 upon receipt of the next input information (e.g., the next frame period for showing an image).

As described above, the information processing device in this embodiment selects a running state (image candidate information) corresponding to the current input information from among a plurality of input candidate information items, and then carries out an application with respect to each of the next input candidate information items.

Note that although three successive input information items (current, previous, and next input information items) are described in the above, obviously, the above described process is successively carried out every time input information is newly obtained.

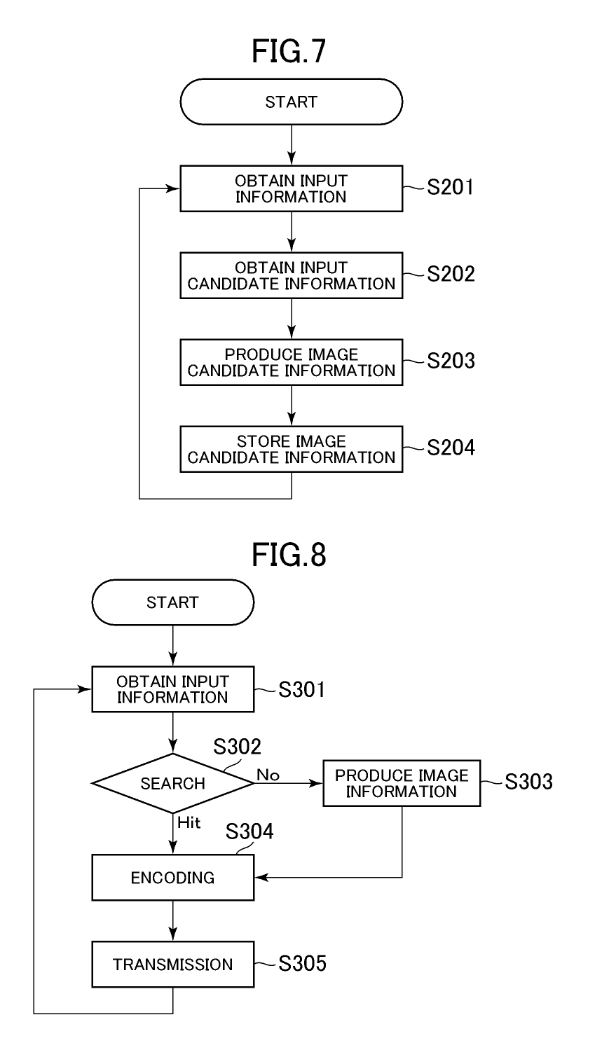

In the following, a process carried out by the server 110 will be described in detail. FIG. 7 is a diagram explaining a flow of an image candidate information producing process carried out by the server 10.

As shown in FIG. 7, the input information obtaining unit 301 obtains input information from the terminal 120 (S201), in which the input information corresponds to the current input information.

The input candidate information obtaining unit 302 searches the input candidate information storage unit 303, based on the current input information, and obtains one or more input candidate information items for the next input information (S202). Based on the one or more input candidate information items, the executing unit 304 produces one or more image candidate information items (S203).

The produced image candidate information items are stored in the image candidate information storage unit 305 so as to be correlated to the respective input candidate information items (S204). Thereafter, returning to S201, a process similar to that at S201 to S204 is carried out with respect to the next input information.

Note that although it is described in the above that the server 110 operates in a constant period, such as for every frame or the like, the server 110 may not necessarily operate in such a manner. For example, when it is determined that no image candidate information corresponding to the current input information is stored, the server 110 may collectively produce image candidate information corresponding to input candidate information for the next and thereafter input information, and collectively send to the terminal 120.

FIG. 8 is a diagram explaining a process from obtaining input information from the terminal 120 by the server 110 to sending image information or image candidate information to the terminal 120.

As shown in FIG. 8, the input information obtaining unit 301 obtains input information from the terminal 120 via the network 130 (S301), in which the input information corresponds to the current input information, and S301 corresponds to S201.

The search unit 307 searches the image candidate information storage unit 305 for input candidate information, based on the current input information received from the input information obtaining unit 301 (S302), in which the input candidate information corresponds to input candidate information as a candidate for the current input information, based on the previous input information and obtained at S202.

Then, when the search unit 307 determines that input candidate information corresponding to the current input information is stored, the process proceeds to S304. Meanwhile, when the search unit 307 determines that no input candidate information corresponding to the current input information is stored, the executing unit 304 produces image information, based on the current input information (S303).

The encoder 308 compresses the image candidate information stored so as to be correlated to the above mentioned input candidate information or the above mentioned image information (S304). The transmitting unit 309 sends the compressed image candidate information or image information to the terminal 120 (S305). Thereafter, returning to S301, an identical process to that at S301 to S305 is carried out to the next input information.

Note that the processes by the server 110 and the terminal 120 shown in FIG. 6 to FIG. 8 are mere examples, and can be modified in various manners. For example, a process substantially identical to the process shown in FIG. 6 to 8, a process producing an identical operational effect, or a process achieving an identical object can substitute the process. For example, the image candidate information may be compressed before being stored in the image candidate information storage unit 305. This arrangement can reduce a time period from searching to transmitting.

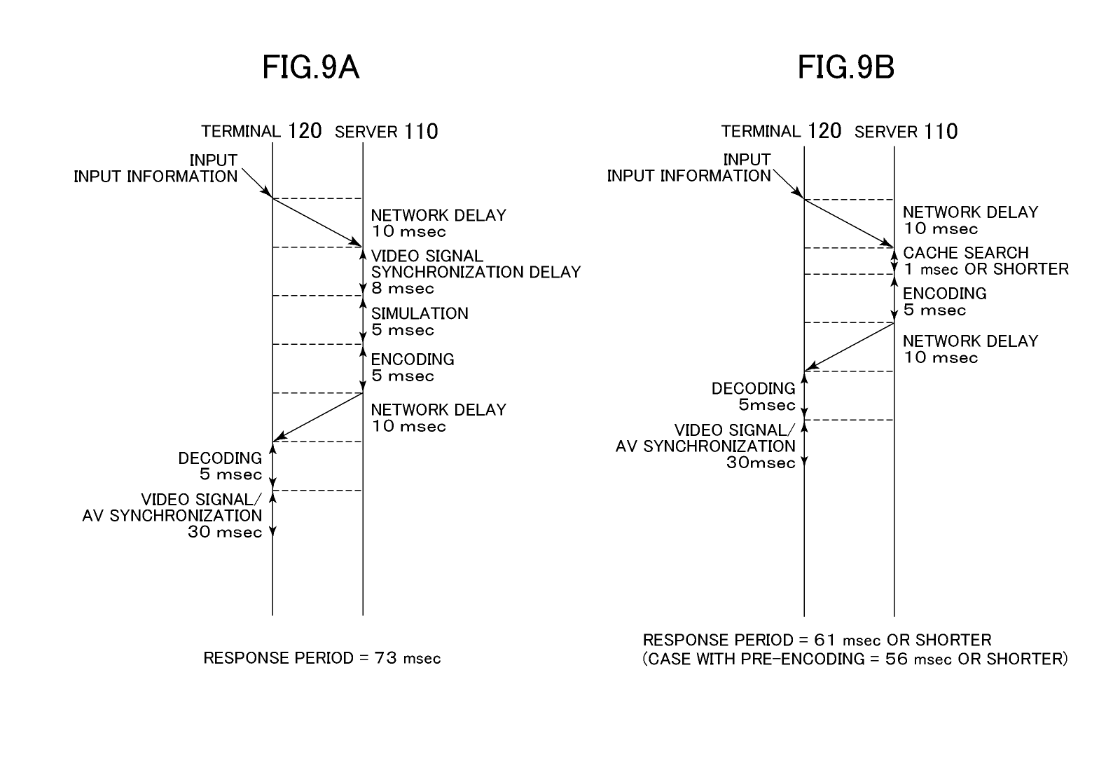

FIG. 9 is a diagram explaining an effect of this embodiment, specifically, showing an example of a time period (a response period) from input of input information to the terminal 120 to reproduction of an image for the input information. FIG. 9A relates to a case in which image candidate information based on input information is not stored; and FIG. 9B relates to an example employing this embodiment.

As shown in FIG. 9A, when no image candidate information based on input information is stored, 10, 8, 5, 5, 10, 5, and 30 msec are required for, from top to bottom in FIG. 9A, network delay, video signal synchronization delay, simulation, encoding, network delay, decoding, and video signal/AV signal synchronization, respectively, in the processes by the server 110, terminal 120, and network 130. In the above, video signal synchronization delay and simulation correspond to a time period necessary for a process by, e.g., the executing unit 304, and video/AV signal synchronization corresponds to a time period necessary for a process by the image reproducing unit 505 of the terminal 120.

Meanwhile, as known from FIG. 9B, in a case in which image candidate information based on input information is stored in the image candidate information storage unit 305, corresponding to the case shown in FIG. 9B, e.g., the time period (8 msec) for video signal synchronization and that (5 msec) for simulation in the process by the executing unit 304 on the server 110 side can be curtailed, compared to the case shown in FIG. 9A. That is, the entire time period from input of input information to the terminal 120 to reproduction of an image for the input information can be reduced by about 12 msec to be 61 msec or shorter in total. Further, in a case in which image candidate information is compressed before storage in the image candidate information storage unit 305, a time period (5 msec) for encoding can be further curtailed, so that the entire time period can be reduced to 56 msec or shorter. In the above, cache search (a process in the search unit 307) is assumed to take 1 msec or shorter.

As described above, according to this embodiment, a response period can be remarkably reduced, compared to a case without employing a structure according to this embodiment. This enables execution of an application, such as playing a game, with a smaller delay. In particular, when a golf game application is carried out, employment of this embodiment is more effective in a scene, such as a shot scene, of the game subjected to remarkable influence of delay in playing the game, for which input information is readily predictable. Note that the above mentioned time periods necessary for the respective processes are mere examples, and not limiting.

Note that the present invention is not limited to the above described embodiment and can be modified in various manners. For example, a structure substantially identical to that described in the embodiment above, a structure producing an identical operational effect, or a structure achieving an identical object can substitute the structure.

### Second Embodiment

In the following, a second embodiment of the present invention will be described. Note that points identical to those in the first embodiments will not be described again below.

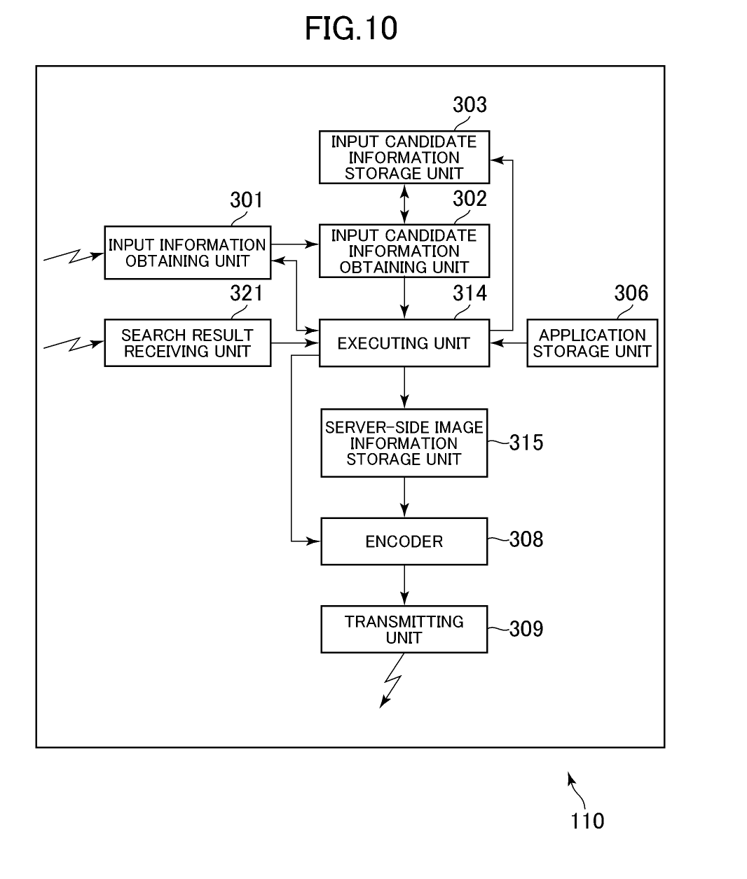

FIG. 10 is a diagram functionally describing a structure of a server in this embodiment. Note that, for brevity of description, input information obtained at a certain time point is referred to as “current input information”; input information obtained at the next time point is referred to as “next input information”; and input information obtained before the time point is referred to as “previous input information”.

As shown in FIG. 10, the server 110 in this embodiment includes the input information obtaining unit 301, the input candidate information obtaining unit 302, the input candidate information storage unit 303, an executing unit 314, a server-side image information storage unit 315, the application storage unit 306, the encoder 308, the transmitting unit 309, and a search result receiving unit 321. For example, mainly the executing unit 314, input candidate information obtaining unit 302, and encoder 308 correspond to the function of the control unit 111; mainly the search result receiving unit 321, input information obtaining unit 301, and transmitting unit 309 correspond to the function of the communication unit 113; and mainly the server-side image information storage unit 315, input candidate information storage unit 303, and application storage unit 306 correspond to the function of the storage unit 112.

The search result receiving unit 321 receives search result information showing that no input candidate information corresponding to the current input information, which is described later, is stored in the terminal 120.

The executing unit 314 carries out an application stored in the application storage unit 306 to produce image information or image candidate information, based on the current input information or input candidate information. Specifically, when the above described search result information is received from the search result receiving unit 321, the executing unit 314 produces image information, based on the current input information. Meanwhile, when the above described search result information is not received from the search result receiving unit 321, the executing unit 314 produces image candidate information, based on the input candidate information received from the input candidate information obtaining unit 302. Note that the executing unit 304 carries out an application on, e.g., an emulator to produce image information or image candidate information.

The server-side image information storage unit 315 stores the image candidate information received from the executing unit 314 so as to be correlated to the input candidate information. Specifically, similar to the first embodiment, for example, an address where the image candidate information is stored is stored so as to be correlated to the input candidate information in the table shown in FIG. 4.

The encoder 308 compresses the image information or image candidate information. The transmitting unit 309 sends the compressed image candidate information or image information to the terminal 120.

Note that the structure of the server 110 shown in FIG. 10 is a mere example, and can be modified in various manners. For example, a structure substantially identical to that shown in FIG. 10, a structure producing identical operational effect, or a structure achieving an identical object can substitute the structure.

Specifically, for example, although the server 110 has the input candidate information storage unit 303 in FIG. 10, a database (not shown) may be provided outside the server 110 so that the input candidate information obtaining unit 302 obtains input candidate information from the database via the network 130. Further, image information or image candidate information may be compressed by the encoder 308 before being stored in the server-side image information storage unit 315 and sent by the transmitting unit 309.

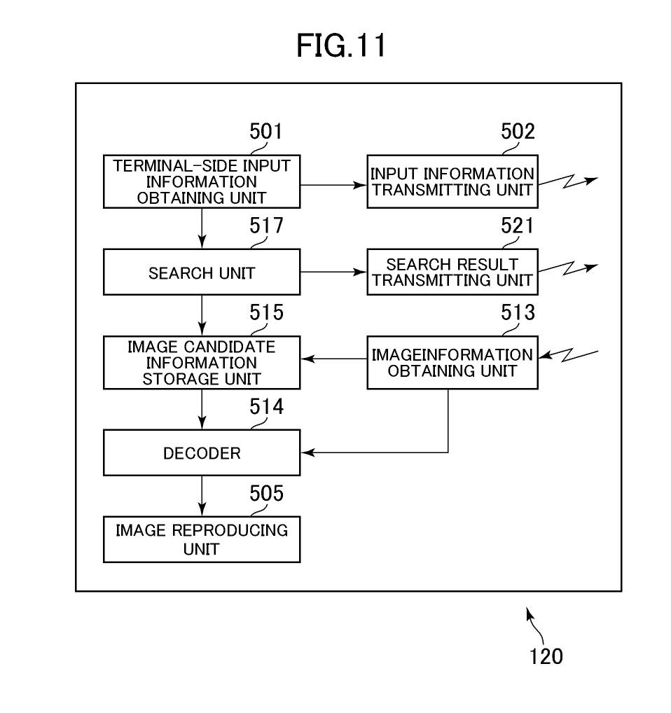

FIG. 11 is a diagram functionally explaining a structure of a terminal. As shown in FIG. 11, the terminal 120 includes a terminal-side input information obtaining unit 501, the input information transmitting unit 502, an image information obtaining unit 513, a search unit 517, an image candidate information storage unit 515, a decoder 514, the image reproducing unit 505, and a search result transmitting unit 521. Note that, for example, mainly the input information transmitting unit 502, search result transmitting unit 521, terminal-side input information obtaining unit 501, and image information obtaining unit 513 correspond to the communication unit 122; mainly the search unit 517, terminal-side input information obtaining unit 501, decoder 514, and image reproducing unit 505 correspond to the control unit 121; and mainly the image candidate information storage unit 515 corresponds to the storage unit 123.

The search unit 517 searches the image candidate information storage unit 515 for image candidate information corresponding to the current input information. When it is determined that image candidate information corresponding to the current input information is stored in the image candidate information storage unit 515, the search unit 517 sends the image candidate information to the decoder 514.

Meanwhile, when the search unit 517 determines that no image candidate information corresponding to the current input information is stored in the image candidate information storage unit 515, the search unit 517 instructs the search result transmitting unit 521 to send search result information to the effect that no input candidate information corresponding to the current input information is stored in the terminal 120. The search result transmitting unit 521 sends such search result information to the server 110.

The image information obtaining unit 513 obtains the compressed image candidate information or image information from the server 110, and then sends the compressed image candidate information to the image candidate information storage unit 515 and the compressed image information to the decoder 514. The decoder 514 decodes the compressed image candidate information or image candidate information.

Note that the structure of the terminal 120 shown in FIG. 11 is a mere example, and can be modified in various manners. For example, a structure substantially identical to that shown in FIG. 11, a structure producing identical operational effect, or a structure achieving an identical object can substitute the structure. A more specific process carried out by the server 110 and the terminal 120 will be described later.

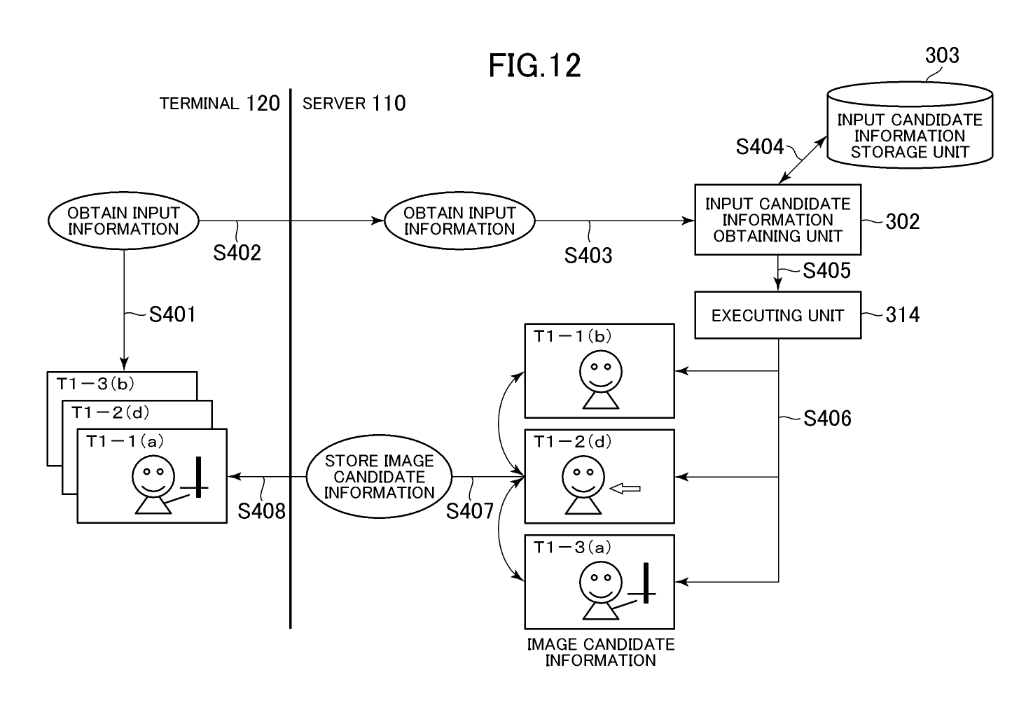

In the following, an operation of an information processing system in this embodiment will be described with reference to FIG. 12.

As shown in FIG. 12, based on the current input information obtained by the terminal-side input information obtaining unit 501, the search unit 517 searches the image candidate information storage unit 515 for image candidate information corresponding to the current input information (S401). The image candidate information is produced in the server 110 based on the previous input information that is input before the current input information, and stored in the image candidate information storage unit 515.

Specifically, as shown in FIG. 12, e.g., image candidate information items T1-1 to T1-3 corresponding to the respective current input information items a, d, b are stored. Assume that the current input information is input information “a”. In this case, the search unit 307 searches for image candidate information related to the button a. In the case shown in FIG. 12, as the image candidate information T11 related to the button a is stored, the search unit 307 determines that image candidate information related to the button a is stored. Then, the decoder 514 decodes the image candidate information T1-1, and the image reproducing unit 505 produces an image of the decoded image candidate information T1-1, and shows the image on the display unit 124.

In the following, an operation on the server 110 side will be described. In particular, in order to coordinate with the image candidate information items T1-1 to T1-3 on the terminal 120 side, a case in which the server 110 obtains previous input information (e.g., input information obtained prior by one frame period to the current input information) will be described.

The input information obtaining unit 301 of the server 110 obtains via the network 130 the previous input information obtained by the terminal-side input information obtaining unit 501 (S402). Based on the previous input information, the input candidate information obtaining unit 302 searches the input candidate information storage unit 303, and obtains input candidate information for the current input information (e.g., input candidate information as a candidate for input information to be likely input in the next frame) (S404), and sends to the executing unit 314 (S405).

Based on the input candidate information, the executing unit 314 carries out an application to produce image candidate information items T1-1 to T1-3 for the respective input candidate information items. The server-side image information storage unit 315 stores the produced image candidate information items T1-1 to T1-3 (S406). Note that, as shown in FIG. 12, the image candidate information items T1-1, T1-2, and T1-3 correspond to input candidate information items related to the buttons a, b, and d, respectively.

The encoder 308 compresses the image candidate information items T1-1 to T1-3 (S407). The transmitting unit 309 sends the compressed image candidate information items T1-1 to T1-3 to the terminal 120 (S408). Note that, for example, the encoder 308 may compress the image candidate information items T1-1 to T1-3, utilizing similarity of the image candidate information items T1-1 to T1-3.

Note that although previous and current input information items are described in the above, the above described process is carried out every time input information is newly obtained.

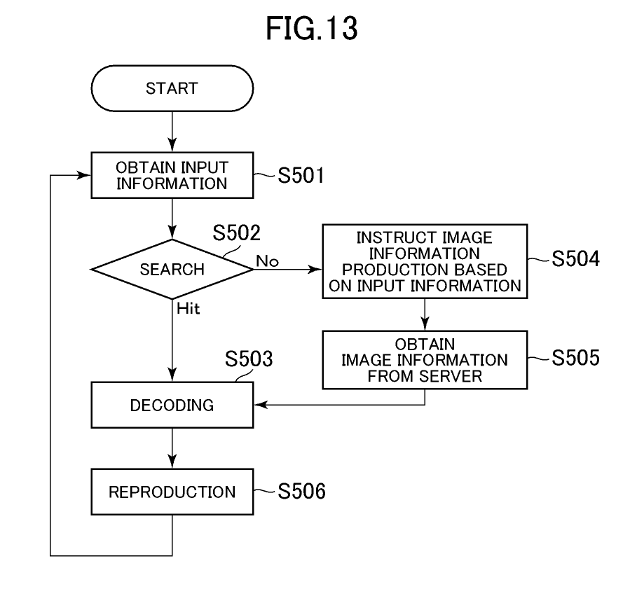

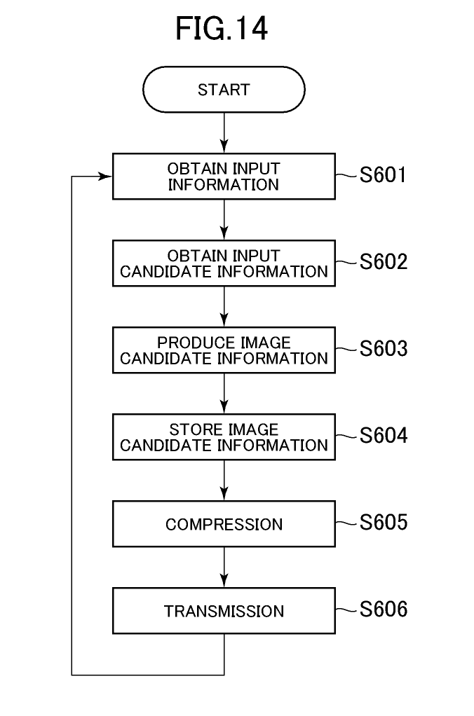

In the following, processes carried out in the terminal 120 and in the server 110 will be described in further detail, referring to FIGS. 13 and 14. FIG. 13 is a diagram explaining a flow of a process carried out in a terminal.

As shown in FIG. 13, the terminal-side input information obtaining unit 501 obtains input information input on the operating unit 125 (S501), in which the input information corresponds to the current input information.

The search unit 517 searches the image candidate information storage unit 515 for image candidate information corresponding to the current input information (S502). When the search unit 517 determines that input candidate information corresponding to the current input information is stored in the image candidate information storage unit 515, the decoder 514 decodes the image candidate information stored so as to be correlated to the current input candidate information (S503).

Meanwhile, when the search unit 517 determines that no input candidate information corresponding to the current input information is stored, the search unit 517 instructs the server 110 to produce image information based on the current input information (S504). Specifically, the search result transmitting unit 521 sends search result information informing absence of input candidate information to the server 110. Thereafter, the image information obtaining unit 503 obtains image information corresponding to the current input information from the server 110 (S505). Then, the decoder 514 decodes the image information (S503).

Based on the decoded image information or image candidate information, the image reproducing unit 505 produces an image, and shows on the display unit 124 (S506). Then, returning to S501, a process similar to that at S501 to S505 is carried out relative to the next input information.

FIG. 14 is a diagram explaining a flow of image candidate information production in the server. Initially, as shown in FIG. 14, the input information obtaining unit 301 obtains input information from the terminal 120 (S601).

Based on this current input information, the input candidate information obtaining unit 302 searches the input candidate information storage unit 303 and obtains one or more input candidate information items for the next input information (S602). Based on the one or more input candidate information items, the executing unit 314 produces one or more image candidate information items (S603). The image candidate information storage unit 305 stores the produced image candidate information items so as to be correlated to the respective input candidate information items (S604).

The encoder 308 compresses the image candidate information received from the image candidate information storage unit 305 (S605). The transmitting unit 309 sends the compressed image candidate information to the terminal 120 (S606). Returning to S601, a process identical to that at S601 to S606 is carried out with respect to the next input information. Note that although it is described in the above that the server 110 operates in a constant period, such as for every frame, or the like, this is not limiting. For example, when it is determined that no image candidate information is stored corresponding to the current input information, the server 110 may collectively produce image candidate information corresponding to input candidate information for the next and thereafter input information, and collectively send to the terminal 120.

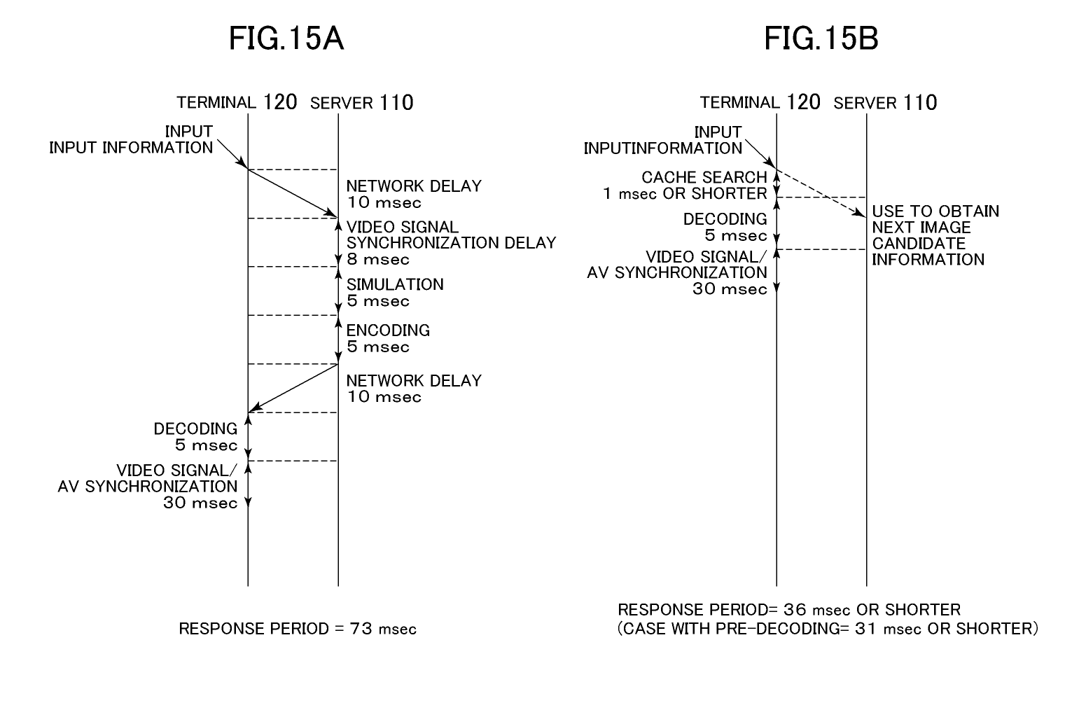

FIG. 15 is a diagram explaining an effect of this embodiment, specifically, showing an example of a time period (a response period) from input of input information to the terminal 120 to reproduction of an image for the input information. FIG. 15A relates to a case in which image candidate information based on input information is not stored; and FIG. 9B relates to an example employing this embodiment. Points common to FIG. 9 will not be described again here.

As known from FIG. 15, in a case in which image candidate information corresponding to input information is stored in the image candidate information storage unit 515 delay due to a process carried out on the server 110 side can be reduced, compared to the case shown in FIG. 15A, though a time period (1 msec or shorter) for cache search is necessary. That is, the entire time period from input of input information to the terminal 120 to reproduction of an image for the input information can be reduced by about 37 msec.

Further, for a structure in which image candidate information is decoded before storage in the image candidate information storage unit 305, the time period can be reduced by another 5 msec.

As described above, according to this embodiment, a response period can be further remarkably reduced, compared to the first embodiment. This makes it possible to carry out an application, e.g., playing a game, with a smaller delay. In particular, when a golf game application is carried out, employment of this embodiment is more effective in a scene, such as a shot scene of the game, subjected to remarkable influence of delay in playing the game, for which input information is readily predictable. Note that the above mentioned time periods necessary for the respective processes are mere examples, and not limiting.

Note that the present invention is not limited to the first or second embodiment, and can be modified in various manners. For example, a structure substantially identical to the structure described in the first or second embodiment, a structure producing an identical operation effect, or a structure achieving an identical object can substitute the structure. For example, a difference between image candidate information items may be obtained before compressing the image candidate information items. Further, although an encoder and a decoder are used in the above, raw data (image information or image candidate information not compressed) may be sent and received without using an encoder or a decoder. Further, although image candidate information corresponding to input information is described in the above, any other candidate information such as audio information, meta information or the like, may be used together with, or instead of, image candidate information.

1. An information processing device comprising:
an input information obtaining unit configured to obtain, via a network, at least first input information and second input information among input information items that are inputted to a terminal device, wherein the second input information is input information subsequent to the first input information;
an input candidate information obtaining unit configured to obtain one or more input candidate information items as a candidate for the second input information, based on the first input information;
an executing unit configured to carrying out an application, based on the one or more input candidate information items, to produce one or more image candidate information items, wherein the one or more image candidate information items are one or more image information items that correspond to the one or more respective input candidate information items;
an image candidate information storage unit configured to store the one or more image candidate information items so as to be correlated to the one or more input candidate information items respectively; and
a transmitting unit configured to send information relating to one or all of the one or more image candidate information items stored in the image candidate information storage unit to the terminal device via a network.

2. The information processing device according to claim 1 further comprising:
a search unit configured to search input candidate information corresponding to the second input information among the one or more image candidate information items stored in the image candidate information storage unit,
wherein when the search unit determines that the input candidate information corresponding to the second input information is stored in the image candidate information storage unit, the transmitting unit sends information relating to image candidate information that is correlated to the input candidate information corresponding to the second input information, to the terminal device.

3. The information processing device according to claim 2, wherein, when the search unit determines that no input candidate information corresponding to the second input information is stored in the image candidate information storage unit,
the executing unit carries out the application based on the second input information to produce image information based on the second input information,
the image candidate information storage unit stores the image information based on the second input information, and
the transmitting unit sends the image information based on the second input information, which is stored in the image candidate information storage unit, to the terminal device.

4. The information processing device according to claim 1 further comprising compressing unit configured to compress the one or more image candidate information items, wherein the transmitting unit sends information relating to one or all of the one or more image candidate information items, which are compressed by the compressing unit, to the terminal device.

5. The information processing device according to claim 4, wherein the storage unit stores the one or more image candidate information items compressed by the compressing unit so as to be correlated to the one or more input candidate information items respectively.

6. An information processing terminal device comprising:
an input information transmitting unit configured to send, via a network, at least first input information and second input information among input information items that are inputted to the information processing terminal device, wherein the second input information is input information subsequent to the first input information;
an image candidate information storage unit configured to obtain and store one or more image candidate information items correlated to one or more respective input candidate information items as a candidate for the second input information;
a search unit configured to search input candidate information corresponding to the second input information among the one or more image candidate information items that are stored in the image candidate information storage unit; and
an image reproduction unit configured to reproduce an image based on image candidate information that is correlated to the input candidate information corresponding to the second input information, when the search unit determines that the input candidate information corresponding to the second input information is stored in the image candidate information storage unit.

7. The information processing terminal device according to claim 6, wherein when the search unit determines that no input candidate information corresponding to the second input information is stored in the image candidate information storage unit, the image reproduction unit obtains image information corresponding to the second input information and reproduces an image based on the image information obtained.

8. An information processing system comprising:
an input information obtaining unit configured to obtain, via a network, at least first input information and second input information among input information items that are inputted to a terminal device, wherein the second input information is input information subsequent to the first input information;
an input candidate information obtaining unit configured to obtain one or more input candidate information items as a candidate for the second input information;
an executing unit configured to carry out an application, based on the one or more input candidate information items, to produce one or more image candidate information items, wherein the one or more image candidate information items are one or more image information items that correspond to the one or more input candidate information items respectively;
an image candidate information storage unit configured to store the one or more image candidate information items so as to be correlated to the one or more corresponding input candidate information items respectively;
a search unit configured to searching input candidate information corresponding to the second input information among the one or more image candidate information items stored in the image candidate information storage unit; and
an image reproduction unit configured to reproduce image candidate information that is stored so as to be correlated to the corresponding input candidate information when the search unit determines that the input candidate information corresponding to the second input information is stored.

9. An information processing method comprising:
obtaining, via a network, at least first input information and second input information among input information items that are input to a terminal device, wherein the second input information is input information subsequent to the first input information;
obtaining one or more input candidate information items as a candidate for the second input information, based on the first input information;
carrying out an application, based on the one or more input candidate information items, to produce one or more image candidate information items, wherein the one or more image candidate information items are one or more image information items that correspond to the one or more input candidate information items respectively;
storing the one or more image candidate information items so as to be correlated to the one or more input candidate information items respectively; and
sending information relating to one or all of the one or more image candidate information items stored in an image candidate information storage unit to the terminal device via a network.

10. An information processing method comprising
obtaining, via a network, at least first input information and second input information among input information items that are inputted to a terminal device, wherein the second input information is input information subsequent to the first input information;
obtaining one or more input candidate information items as a candidate for the second input information;
carrying out an application, based on the one or more input candidate information items, to produce one or more image candidate information items, wherein the one or more image candidate information items are one or more image information items that correspond to the one or more input candidate information items respectively;
storing the one or more image candidate information items so as to be correlated to the one or more corresponding input candidate information items respectively;
searching input candidate information corresponding to the second input information among the one or more image candidate information items stored in an image candidate information storage unit; and
when no input candidate information corresponding to the second input information is stored, reproducing image candidate information stored so as to be correlated to the corresponding input candidate information.

11. A non-transitory, computer readable storage medium storing an information processing program for causing a computer to function as:
an input information obtaining unit configured to obtain, via a network, at least first input information and second input information among input information items that are inputted to a terminal device, wherein the second input information is input information subsequent to the first input information;
an input candidate information obtaining unit configured to obtain in one or more input candidate information items as a candidate for the second input information, based on the first input information;
an executing unit configured to carry out an application, based on the one or more input candidate information items, to produce one or more image candidate information items, wherein the one or more image candidate information items are one or more image information items that correspond to the one or more input candidate information items respectively;
an image candidate information storage unit configured to store the one or more image candidate information items so as to be correlated to the one or more input candidate information items respectively; and
a transmitting unit configured to send information relating to one or all of the one or more image candidate information items stored in the image candidate information storage unit to the terminal device via a network.

12. A non-transitory, computer readable storage medium storing an information processing program for causing a computer to function as:
an input information transmitting unit configured to send, via a network, at least first input information and second input information among input information items that are input into a terminal device, wherein the second input information is input information subsequent to the first input information;
an image candidate information storage unit configured to obtain and store one or more image candidate information items correlated to one or more respective input candidate information items as a candidate for the second input information;
a search unit configured to search input candidate information corresponding to the second input information among the one or more image candidate information items that are stored in the image candidate information storage unit; and
an image reproduction unit configured to reproduce an image based on image candidate information correlated to the input candidate information corresponding to the second input information when the search unit determines that the input candidate information corresponding to the second input information is stored in the image candidate information storage unit.

13. The information processing device according to claim 3, wherein the executing unit stores a running state of the executing unit, and wherein when the search unit determines that no input candidate information corresponding to the second input information is stored in the image candidate information storage unit, the executing unit carries out the application based on the running state stored.
